(19) United States
(12) Patent Application Publication
(10) Pub. No.: US 2006/0067801 A1
(43) Pub. Date: Mar. 30, 2006

(54) Portable router having an inerchangeable handle

(75) Inventor: Jonathan R. Van Bergen, Clemson, SC (US)

Correspondence Address: BRINKS HOFER GILSON & LIONE, P.O. BOX 10395, CHICAGO, IL, 60610, US

(73) Assignee: One World Technologies Limited

(21) Appl. No.: 10/949,580

(22) Filed: Sep. 24, 2004

(51) Int. Cl. B23C 1/20

(52) U.S. Cl. 409/182

(57) ABSTRACT

A portable router base having a removable handle is provided. The base is configured to be operatively connected to a motor. The base includes a first handle attached thereto, and a second handle being removably interchangeable with respect to the base. The base has a handle mounting area configured to receive a connector on the second handle, thereby allowing the removable handle to be interchangeable.

### FIELD OF THE INVENTION

This invention relates to power tools, and more particularly, to a portable router having at least one interchangeable handle.

### BACKGROUND

A router is a tool typically used to shape and form predetermined edges of a workpiece by utilizing a motor having a rotating cutting tool that is oriented in a generally vertical direction. The cutting tool can vary in shape in order to provide a particular type of resulting edge of the workpiece. The cutting tool rotates at a high speed, and as the cutting tool contacts the edge of the workpiece, small shavings of the edge are removed in order to generate a smooth edge having a pre-determined contour or shape. Historically, routers have been constructed as a one-piece electrical tool, but routers can also be portable and consist of a motor portion that is removably connected to different types of bases depending upon the type of purpose for which the router is being used. Thus, the removability of the motor from the base allows for more portability of the motor between the different types of bases.

Portable routers typically consist of a motor portion that is configured to be removably connected to a base. The motor portion includes a motor that drives a rotary cutting tool extending from the motor. The motor is generally operatively connected to the top portion of the base such that the rotary tool is extends centrally through the base toward the workpiece. The types of bases that are configured to receive the motor portion vary, depending upon the application for which the portable router is being used. The common types of portable router bases are a plunge base, a fixed base, and a D-handle base. Each of these types of router bases serves a different purpose for a user, and the user generally must purchase each of these bases separately. In addition, the user needs additional storage space in order to accommodate all three of the bases.

The plunge base provides a receiving portion in which the removable motor is disposed, and a surface that contacts the workpiece in order to stabilize the base with respect to the workpiece. The plunge base allows the user to actuate the motor portion in a generally vertical manner, toward and away from the workpiece in a normal direction, in order to generate a bore in the workpiece or generate a patterned edge in the direction of the plunging movement. The plunge base is generally maintained in a fixed position relative to the workpiece as the motor portion is actuated in an up-and-down manner relative to the workpiece.

The fixed base likewise provides a receiving portion in which the removable motor is disposed and a surface that contacts the workpiece to stabilize the base with respect to the workpiece. The fixed base is configured to allow the user to move the base along the workpiece such that the rotary cutting tool extends downward from the motor portion and creates a stylized pattern in the workpiece as the fixed base is maneuvered by the user. Typically, the fixed base includes a pair of egg-shaped handles on opposing sides of the base so that the user can maintain control of the fixed base and motor portion while moving the base relative to the workpiece. The fixed base provides the motor portion a constant depth for the rotary cutting tool as the user moves the base across the surface of the workpiece in a fore-aft manner, a side-to-side manner, or any direction therebetween.

The D-handle base provides a receiving portion in which the removable motor is configured to be releasably disposed. The D-handle base is configured to allow the user to move the base along the workpiece such that the rotary cutting tool extends downward from the motor portion and creates a stylized pattern in the workpiece. The D-handle base typically includes an egg-shaped handle and a D-handle located on opposing sides of the base. Typically, the D-handle base is designed to allow the user to grip only the D-handle on the base and maneuver the base in a pushing manner such that the D-handle base is guided away from the user.

The fixed base and the D-handle base are configured to be slid along the surface of a workpiece such that the rotary cutting tool is maintained at a pre-determined depth, whereas the plunge base is configured to remain stationary relative to the workpiece as the motor portion is actuated to change the cutting depth of the rotary cutting tool while in use. In addition, the fixed base is configured such that the user maneuvers the base along the surface of the workpiece by gripping both egg-shaped handles, whereas the D-shaped base is configured such that the user maneuvers the base along the surface of the workpiece by gripping only the D-handle.

The portable router having an interchangeable handle of the present invention provides an advantage over the three separate router bases by combining the fixed base and the D-handle base into a single base. At least one handle is interchangeable between at least an egg-shaped handle and a D-handle such that the removal of one type of handle and the replacement with the other type of handle provides the user with both multiple types of bases without the need to purchase multiple bases. By combining at least two types of bases into one, the user saves additional space in the workspace or toolbox. In addition, by combining at least two types of bases into a single base, the cost to the user is reduced.

### BRIEF SUMMARY

The present invention eliminates the need for multiple bases for a portable router by providing the base with a mechanism that allows for at least one handle to be interchangeably connected to the base. The embodiments described herein allow for a cost-efficient, space-saving base that eliminates the need for a plurality of bases having substantially similar characteristics yet providing different functions to a user. Such interchangeability increases the modifiability of a router base, thereby expanding the possible uses of a single base.

In one aspect of the invention, a portable router having an interchangeable handle is provided. The apparatus includes a motor and a first handle connected to a base, and a second handle removably connected to the base, thereby providing interchangeability of the second handle. In another aspect of the invention, the base has a handle mounting area and the second handle has a connector, and the handle mounting area of the base is configured to receive the connector of the second handle.

Advantages of the present invention will become more apparent to those skilled in the art from the following description of the preferred embodiments of the invention which have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is an exploded view of one embodiment of a router having a D-handle base;

FIG. 2 is a perspective view of a first embodiment of a fixed base;

FIG. 3 is an exploded view of a first embodiment of a router base having an interchangeable handle;

FIG. 4 is a perspective view of a first embodiment of a D-handle;

FIG. 5 is a plan view of the D-handle thereof;

FIG. 6 is a top view of the D-handle thereof;

FIG. 7 is a plan view of a second embodiment of a D-handle;

FIG. 8 is a bottom view of the D-handle thereof; and

FIG. 9 is a perspective view of a router base having third embodiment of an interchangeable D-handle.

### DETAILED DESCRIPTION OF THE DRAWINGS AND THE PRESENTLY PREFERRED EMBODIMENTS

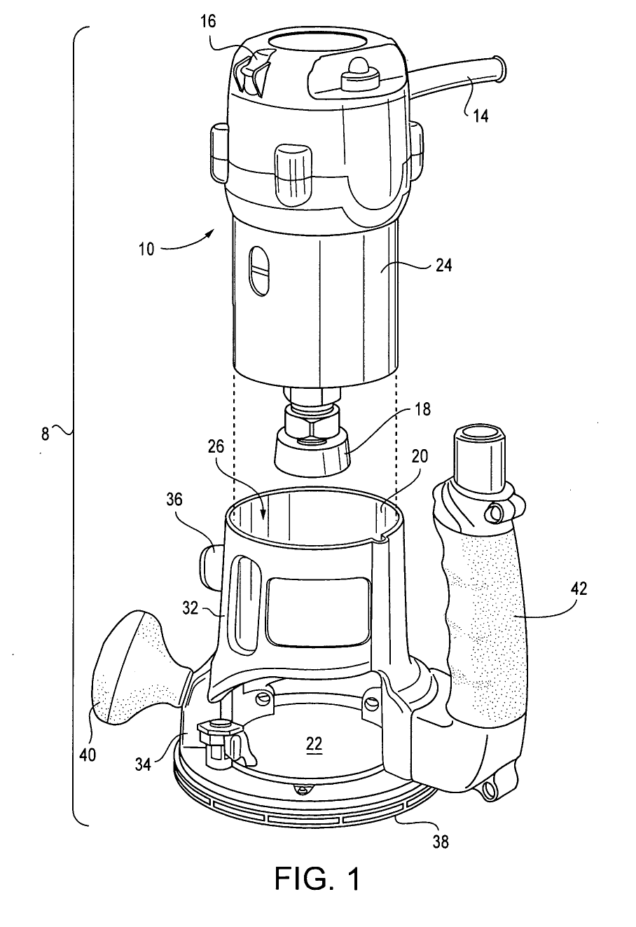

FIG. 1 illustrates one embodiment of a portable router 8 having a motor 10 and a base 12. The motor 10 is removably attached the base 12 in order to allow the user to remove the motor 10 from the base 12 such that the motor can then be operatively connected to a different base. The motor 10 is shown as having an electrical cord 14, but it should be understood that the motor can be powered by any other means, including, but not limited to, a battery pack or individual batteries. The motor 10 includes a power switch 16 that is actuated between an on and an off position, thereby selectively generating rotary power to the cutting tool 18. A cutting tool 18 extends in a downward manner from the motor 10 when the motor is disposed within a first aperture 20 of the base 12.

The motor 10 is removably connected to the base 12 by inserting the cutting tool 18 through the first aperture 20 such that the cutting tool 18 is directed toward the second aperture 22 of the base 12, and then lowering the motor 10 until a portion of the motor housing 24 is surrounded by the base 12 and the cutting tool 18 is disposed within the central bore 26 of the base 12. Once the motor 10 has been disposed within the central bore 26 of the base 12, the motor housing 24 is operatively connected to the base 12 by a clasp (not shown) that effectively reduces the circumference of the first aperture 20 of the base 12, thereby providing a frictional connection between the motor housing 24 and the base 12. To remove the motor 10 from the base 12, the clasp is unfastened so as to release the frictional connection and the motor housing 24 is lifted in a separating manner away from the base 12.

The power generated by the motor 10 is selectively chosen by the user via the power switch 16. When the power switch 16 is in an on position the motor 10 generates rotary power to the cutting tool 18, and when the power switch 16 is in an off position the motor 10 does not generate rotary power to the cutting tool 18. FIG. 1 shows the motor 10 having a power switch 16 that is manually operated by the user independent from the handles of the base. However, it should be understood by one skilled in the art that the base can be configured to have a power switch being operatively connected to at least one handle that extends from the base.

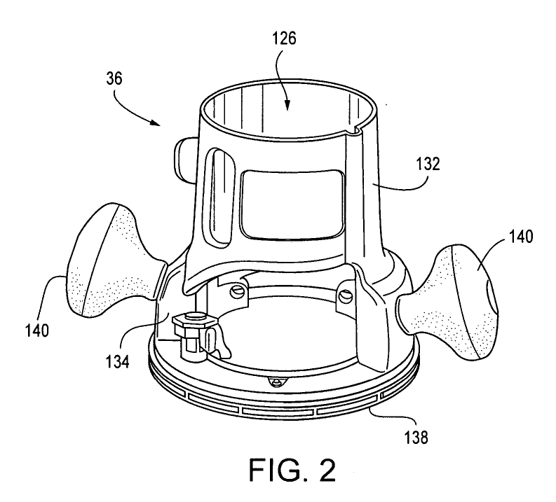

The type of base used in conjunction with the removable motor 10 is dependent upon the operation for which the portable router 8 is being used. Examples of alternative types of bases include a D-handle base, as shown in FIG. 1, a fixed base, as shown in FIG. 2, and a plunge base (not shown).

One embodiment of a base for receiving a motor is a D-handle base 12, illustrated in FIG. 1. The D-handle base 12 is generally cylindrical having a central bore 26 formed axially therethrough such that the central bore 26 has a generally vertical orientation. The D-handle base 12 includes an upper portion 32 and a lower portion 34 that form the perimeter about the central bore 26. The upper portion 32 is configured to receive the motor 10 and maintain the motor 10 in a pre-defined position relative to a workpiece while the portable router 8 is in use. The depth of cut of the cutting tool 18 extending from the motor 10 can be adjusted in a generally vertical manner using the vertical adjustment mechanism 36. The vertical adjustment mechanism 36 allows the user to manually adjust the height of the cutting tool relative to the workpiece. Once the user has chosen the height of the cutting tool 18 relative to the workpiece by adjusting the vertical adjustment mechanism 36, the cutting depth remains fixed until the user adjusts the height of the cutting tool 18 in the same manner. The D-handle base 12 provides a constant depth of cut for the cutting tool 18 by preventing the motor 10 from moving in the vertical direction while in use.

The lower portion 34 of the D-handle base 12 includes a second aperture 22 through which the cutting tool 18 extends from the D-handle base 12 when the router 8 is in use. The lower portion 34 further includes a sliding surface 38 located on the bottom of the D-handle base 12, wherein the sliding surface 38 is directed toward a workpiece and is configured to be in sliding contact with the workpiece as the router 8 is maneuvered.

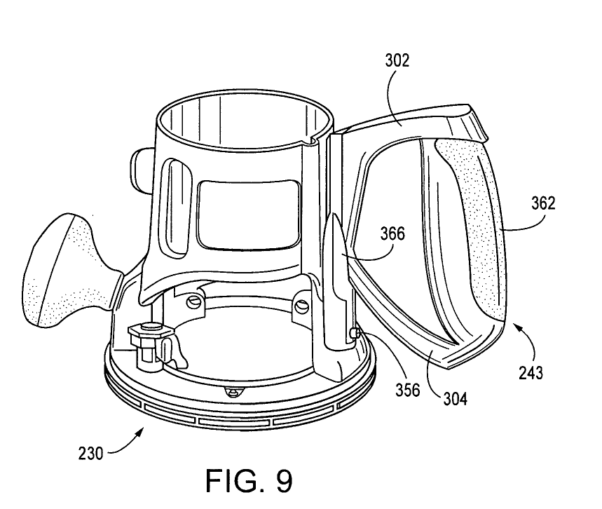

The lower portion 34 of the preferred embodiment of the D-handle base 12 illustrated in FIG. 1 has an egg-shaped handle 40 and a D-handle 42 extending from the outer surface of the lower portion 34. It should be understood by one skilled in the art that a D-handle base 12 can be configured having an egg-shaped handle 40 and a D-handle 42 or a pair of D-handles 42 disposed on the base 12. The handles 40, 42 are disposed on opposing sides of the lower portion 34 of the base 12. The D-handle base 12 thus provides two graspable handles 40, 42 to which the user can use to maneuver the router 8 over a workpiece. The D-handle 42 illustrated in FIG. 1 does not have a D-shape as the name suggests, but a D-handle is typically any handle that provides a graspable surface having a generally vertical orientation that the user grasps in order to maneuver the base in a pushing manner. For example, an alternative embodiment of a D-handle 243 is shown in FIG. 9, and has a vertically oriented graspable handle having a D-shape.

In operation, a router 8 having a D-handle base 12 is typically used in such a manner that the user is positioned near one edge of a workpiece such that an adjacent edge of the workpiece extends in a direction away from the user, and the user grasps only the D-handle 42 and maneuvers the router 8 in a pushing manner away from the user to shape and form the edge of the workpiece that extends away from the user. The use of the router 8 having a D-handle base 12 in this manner provides the user with an advantageous line of sight because the user can see the entire length of the edge of the workpiece being machined. Furthermore, the D-handle 42 provides an ergonomic gripping surface to which the user can grasp. While this is an exemplary method of maneuvering a router having a D-handle base, it should be understood by one skilled in the art that the router having a D-handle base can also be maneuvered in any other manner sufficient to shape and form an edge of a workpiece.

A second embodiment of a base for receiving a motor is a fixed base 30, illustrated in FIG. 2. The fixed base 30 has a top portion 132, a bottom portion 134, a central bore 126, a sliding surface 138, and a pair of opposing egg-shaped handles 140. The top portion 132 is configured to receive a removable motor 10 (FIG. 1) that is disposed within the central bore 126. The top portion 132 is configured to provide a releasable connection between the base 30 and a motor 10. The fixed base 30 provides a constant depth of cut for the cutting tool 18 by preventing the motor 10 from moving in the vertical direction while in use.

The pair of egg-shaped handles 140 are disposed on opposing sides of the lower portion 134 of the fixed base 30 and extend in an outward direction therefrom. The egg-shaped handles 140 have a generally oblong shape to provide the user with an ergonomically efficient gripping surface.

In operation, a router having a fixed base 30 is typically used in such a manner that the user is positioned near the edge of a workpiece that the user is shaping or forming with the router, and the user grasps both opposing egg-shaped handles 140 and maneuvers the fixed base 30 along the edge of the workpiece that the user is forming or shaping. Because the user grips both handles of the fixed base, the user can maneuver the router in both a fore/aft or a side-to-side motion. The use of a router having a fixed base 30 in this manner provides the user with the freedom to generate formed edges in multiple directions from the position of the user because the user can maintain control of the router with both hands. While this is an exemplary method of maneuvering a router having a fixed base, it should be understood by one skilled in the art that the router can also be maneuvered in any other manner sufficient to shape and form an edge of a workpiece. Generally, the type of base dictates the manner in which the base is to be used. For example, a D-handle base is typically used in a pushing manner, a fixed base is typically used in a manner providing for fore/aft, lateral, or any manner therebetween, and a plunge base is typically used for vertical actuation of the motor and cutting tool.

The D-handle base 12 and the fixed base 30 are both configured to slide along the surface of a workpiece such that the rotary cutting tool 18 that extends downward from the motor 10 creates a stylized pattern along the edge of the workpiece. Although both bases 12, 30 have generally the same type of base, wherein the type of handles extending therefrom is typically the distinguishing characteristic, the manner in which each base is used is different. Although either base 12, 30 can be used in a manner in which the other is generally used, a user usually purchases both types of bases in order to generate a desired shaped edge in an efficient manner from the particular base.

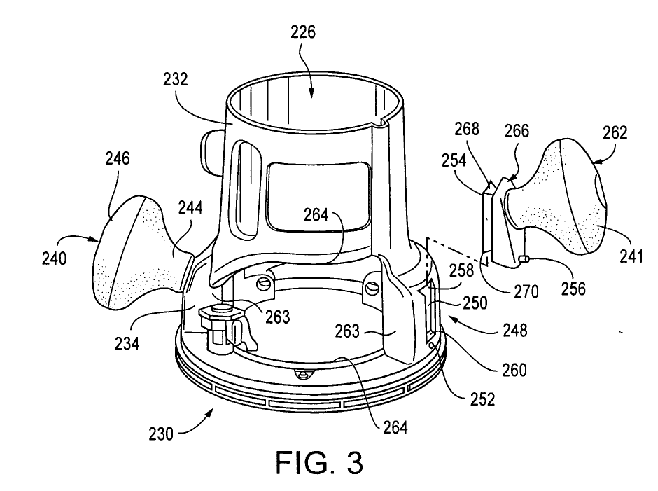

FIG. 3 illustrates the preferred embodiment of a base 230 having a removable handle 241 configured to be interchangeable such that at least one handle can be replaced if damaged or interchanged with an alternative type of handle. The base 230 is similar to the D-handle base 12 shown in FIG. 1 as well as the fixed base 30 shown in FIG. 2 as it is configured to receive a removable motor 10 and provides the user with at least one graspable handle to maneuver the base across the surface of a workpiece. The base 230 is further configured to allow the user to remove at least one handle therefrom in order to modify the characteristics of the base.

The base 230 preferably has a first handle 240 attached to the bottom portion 234 such that the first handle 240 extends therefrom, as shown in FIG. 3. The first handle 240 is preferably fixed to the base 230. The base 230 also includes an interchangeable second handle 241 that is removably attached to the lower portion 234, and the interchangeable second handle 241 is located opposite the first handle 240 on the base 230. It should be understood by one skilled in the art that the first handle 240 or the second handle 241 can be interchangeable such that the other handle is fixedly attached to the base, or both the first and second handles 240, 241 can be interchangeable. The lower portion 234 includes a window defined by opposing vertical edges 263 that connect opposing horizontal edges 264, wherein the window is located between the first and second handles 240, 241. The window allows the user to view the cutting tool 18 contacting the workpiece. The window has an arc length between about ninety to one-hundred eighty (90-180) degrees. The first and second handles 240, 241 are preferably connected to the lower portion 234 of the base 230 immediately adjacent to the vertical edges 263 of the window. It should be understood by one skilled in the art that the base 230 may not include a window disposed within the lower portion 234, yet the handles can remain operatively connected to the lower portion 234 of the base 230.

The handles 240, 241 are preferably located on opposing sides of the lower portion 234 of the base 230 in a manner such that the handles 240, 241 are oriented at an angle of between about 100-180 degrees with respect to each other about the central bore 226. Preferably, the handles 240, 241 are oriented at an angle of about 170 degrees about the central bore and with respect to each other. It should be understood by one skilled in the art that the handles 240, 241 can be oriented at any angle relative to each other.

In the preferred embodiment, the first handle 240 is integrally attached to the lower portion 234 of the base 230 such that the first handle 240 is not interchangeable. However, it should be understood by one skilled in the art that the first handle can be removably connected to the base, thereby providing interchangabitlity of the first handle with respect to the base. The first handle 240 is preferably and egg-shaped handle, because both the D-handle base 12 (FIG. 1) and the fixed base 30 (FIG. 2) each typically have at least one egg-shaped handle 40, 140 attached thereto. It should be understood by one skilled in the art that an egg-shaped handle need not be attached to the base for either the fixed or D-handle base. The first handle 240 being egg-shaped provides the user with at least one handle in which to grasp and control the movement of the base 230 relative to a workpiece.

The egg-shaped first handle 240 has a reduced portion 244 connected to the lower portion 234 of the base 230 and the reduced portion 244 extending in an outward direction therefrom. As the reduced portion 244 extends from the lower portion 234, the cross-section of the reduced portion 244 increases. The reduced portion is integrally formed with the grip portion 246 of the first handle 240. The egg-shaped first handle 240 is preferably made of plastic and is covered by a rubberized overmold. The rubberized overmold is generally achieved by a spray-on texture or rubber being glued onto the outer surface of the plastic.

The lower portion 234 of the base 230 further includes a handle mounting area 248 that is configured to receive a connector 249 of an interchangeable second handle 241, as illustrated in FIG. 3. The handle mounting area 248 of the base 230 further includes a receiving portion 250 and a securing portion 252. The connector 249 of the interchangeable second handle 241 further includes a connecting member 254 and a securing member 256. The receiving portion 250 is preferably a recessed cavity that receives the connecting member 254 extending from the interchangeable second handle 241. The securing portion 252 is configured to receive the securing member 256 that operatively connects and secures the interchangeable second handle 241 to the base 230. The handle mounting area 248 can receive both an egg-shaped handle and a D-handle. However, it should be understood by one skilled in the art that any type of handle, including but not limited to the egg-shaped handle and the D-handle, can be secured to the base 230 by way of the handle mounting area 248.

The receiving portion 250 and the connecting member 254 preferably form a mortise and tenon joint, as illustrated in FIG. 3. The receiving portion 250 is the mortise, having an elongated cavity that is oriented in a generally vertical direction, and the cavity extends radially inward from the outer surface of the lower portion 234 of the base 230 toward the central bore 226. The connecting member 254 is the tenon, forming an elongated protrusion extending from the central portion 266 of the interchangeable second handle 241. It should be understood by one skilled in the art that the mortise and tenon components can be disposed on either the base or the interchangeable handle. For example, the interchangeable second handle 241 can have a mortise formed therein and the base 230 having a corresponding tenon protruding therefrom. More particularly, the mortise and tenon joint between the receiving portion 250 and the connecting member 254 is preferably a dovetail joint. The dovetail shape of the receiving portion 250 is a cavity that extends radially inward from the outer surface of the lower portion 234 such that the cross-section increases as the cavity extends inward, as illustrated in FIG. 3. The cavity forming the receiving portion 250 has an open end 258 and a closed end 260. The open end 258 is configured to allow the connecting member 254 of the interchangeable second handle 241 to be inserted into the receiving portion 250, and the closed end 260 provides a stop to which the connecting member 254 abuts, thereby locating the connecting member 254 within the receiving portion 250. It should be understood by one skilled in the art that the cavity forming the receiving portion 250 and the connecting member 254 can be any complementary shapes sufficient to maintain a connection between the interchangeable second handle 241 and the base 230. It should also be understood by one skilled in the art that the connecting member 254 and the receiving portion 250 can be oriented in any direction sufficient to provide an abutting connection between the interchangeable second handle 241 and the base 230.

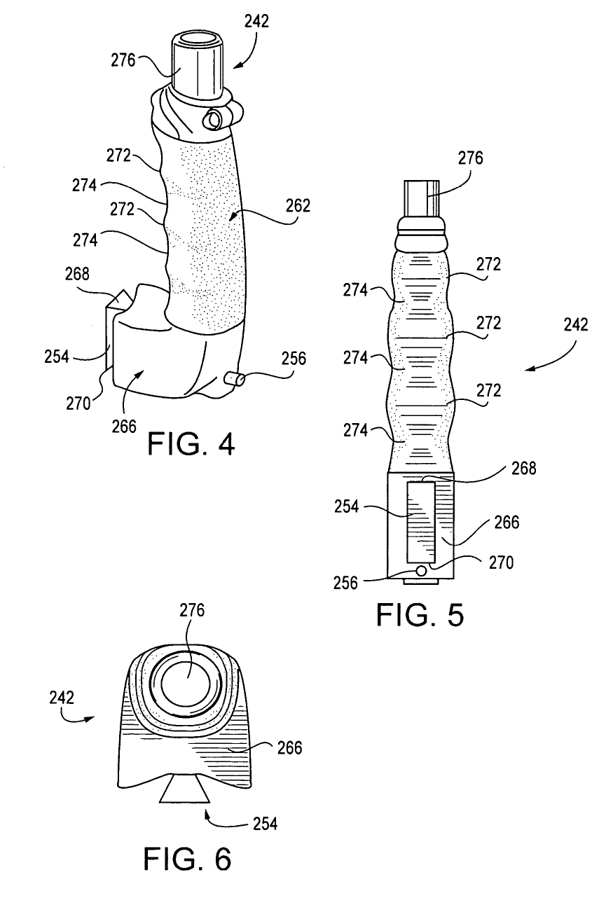

The interchangeable second handle 241 includes a central portion 266, a graspable portion 262 and the connector 249. The connector 249 of the interchangeable second handle 241 includes a connecting member 254 and a securing member 256. The graspable portion 262 extends from one side of the central portion 266 and the connector 249 matingly engages the receiving portion 250 of the base 230, thereby securing the interchangeable second handle 241 to the base 230. One embodiment of an interchangeable second handle 241 is an egg-shaped handle, as illustrated in FIG. 3, a second embodiment of an interchangeable second handle 242 is a D-handle, as illustrated in FIGS. 4-6, and a third embodiment of an interchangeable second handle 243 is an alternative-type D-handle, as illustrated in FIG. 9. It should be understood by one skilled in the art that other types of graspable handles can be used as a second handle, provided that the handle includes structure that allows for interchangeability with the base 230. The connecting and securing structures of the interchangeable second handle 241 are described hereafter with reference to the egg-shaped handle illustrated in FIG. 3, but it should be understood that the same connecting and securing structures must be integral with the first and second embodiments of the D-handle illustrated in FIGS. 4-7.

In the preferred embodiment, the connecting member 254 is vertically oriented, having a top end 268 and a bottom end 270. The dimensions of the cross-section of the connecting member 254 are constant between the top and bottom ends 268, 270, as illustrated in FIGS. 5-6. The shape of the cross-section of the connecting member 254 is identical to the cross section of the receiving portion 250 of the base 230, wherein the dimensions of the connecting member 254 are slightly smaller than those of the receiving portion 250 such that a snug, mating connection is formed between the connecting member 254 of the interchangeable second handle 241 and the receiving portion 250 of the base 250 as the connecting member 254 is inserted into the open end 258 of the receiving portion 250. The mating connection between the interchangeable second handle 241 and the base 230 is achieved by inserting the bottom end 270 of the connecting member 254 into the open end 258 of the receiving portion 250, as illustrated in FIG. 3. The connecting member 254 is then slid vertically downward until the bottom end 270 of the connecting member 254 abuts the closed end 260 of the receiving portion 250 such that the bottom end 270 is immediately adjacent the closed end 260. When the bottom end 270 of the connecting member 254 abuts the closed end 260 of the receiving portion 250, the top end 268 of the connecting member 254 is substantially coplanar with the open end 258 of the receiving portion 250, thereby positively locating the interchangeable second handle 241 relative to the base 230. It should be understood by one skilled in the art that the connecting structure between the interchangeable second handle 241 and the base 230 can be reversed such that the recessed receiving portion 250 can be located on the interchangeable second handle 241 and the protruding connecting member 254 is extending from the lower portion 234 of the base 230.

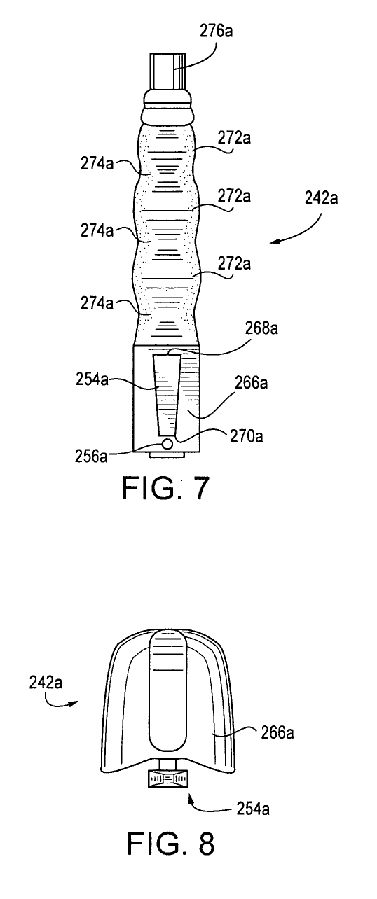

In an alternative embodiment, illustrated in FIGS. 7-8, the connecting member 254a extends from the central portion 266a of the D-handle 242a such that the connecting member 254a is vertically oriented. The connecting member 254a includes a top end 268a and a bottom end 270a, wherein the top end 268a is wider than the bottom end 270a, thereby having a tapered shape. In addition, as shown in FIG. 8, front and rear surfaces of the connecting member 254a are also tapered such that the top end 268a has both a greater length and a greater width than the bottom end 270a. The receiving portion on the base is a cavity having a complimentary shape such that the bottom end 270a of the D-handle 242a abuts the closed end of the receiving portion of the base, and the top end 268a is substantially coplanar with the open end of the receiving portion of the base when the connecting member 254a is disposed within the receiving portion of the base.

The interchangeable second handle 241 is secured to the base 230 by the way of a securing member 256, as shown in FIGS. 4-5. Once the interchangeable second handle 241 is positively located relative to the base 230, the securing member 256 is connected to the securing portion 252, thereby preventing the interchangeable second handle 241 from sliding relative to the base 230. In the preferred embodiment, the securing member 256 is a thumb screw having threads extending radially outward, and the securing member 256 is threaded through the central portion 266 of the interchangeable second handle 241. The securing portion 252 is preferably an orifice in the base 230 having threads about the inner surface of the orifice that correspond to the threads on the outer surface of the thumb screw. To secure the interchangeable second handle 241 to the base 230, the user causes the securing member 256 to rotate such that the end of the securing member 256 directed toward the base 230 enters the securing portion 252, thereby creating a threaded engagement between the interchangeable second handle 241 and the base 230. Thus, when the interchangeable second handle 241 is fully engaged and secured to the base 230, the securing member 256 is threadably engaged through the central portion 266 of the interchangeable second handle 241 and is inserted into the securing portion 252 of the base 230. It should be understood by one skilled in the art that any type of structure sufficient to prevent the interchangeable second handle 241 from moving relative to the base 230 can be used as a securing member to secure the interchangeable second handle 241 to the base 230. Such structures include, but are not limited to, a keying structure, a cap to cover the open end, a buckle, or a latch.

The interchangeable D-handle 242 further includes a graspable portion 262 that is integrally formed with the central portion 266, as illustrated in FIGS. 4-5. The graspable portion 262 extends in a vertical manner from the central portion 266. The graspable portion 262 has a plurality of spaced-apart raised regions 272 with a recessed region 274 extending therebetween. These raised and recessed regions 272, 274 provide an area configured for the user's fingers to grip. The graspable portion 262 also includes a protrusion 276 that extends vertically at the top of the graspable portion 262. The protrusion 276 provides a location on which the user can rest the thumb of the hand used to grip the handle 242. This shape of the D-handle provides the user with an ergonomically advantageous grip of the D-handle 242.

The interchangeable second handle 243, illustrated in FIG. 9 as an alternative embodiment of a D-handle, includes a graspable portion 362, an upper closure portion 302, a lower closure portion 304, a central portion 366, and a connector (not shown). The top end of the graspable portion 362 of the D-handle 243 is joined to the central portion 366 by the upper closure portion 302, and the bottom end of the graspable portion 362 is joined to the central portion 366 by the lower closure portion 304. The D-handle 243 includes a connector that allows for the interchangeability of the second handle with other types of handles. The D-handle 243 further includes a securing member 356, shown as a thumb screw, to secure the D-handle 243 to the base 230.

The base 230 having interchangeable handles 241, 242, 243 being removable allows the user to modify the characteristics of the base 230 by replacing one type of handle with another. The base 230 being configured to receive an interchangeable egg-shaped handle, as shown in FIG. 3, as well as a D-handle, shown in FIGS. 4-9, effectively reduces the number of bases necessary to perform the same function in the same manner as the bases that do not provide for interchangeable handles. In addition, a single base 230 configured to replace two different bases will also provide space savings within a workspace or toolbox.

While preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

1. A portable router comprising a motor, a base having a central bore, a first handle attached to said base, and a second handle removably attached to said base.

2. The portable router of claim 1, wherein said second handle is interchangeable.

3. The portable router of claim 2, wherein said base further includes an outer surface and a handle mounting area located on said outer surface of said base.

4. The portable router of claim 3, wherein said handle mounting area includes a receiving portion and a securing portion.

5. The portable router of claim 2, wherein said second handle includes a connector, and said base includes a handle mounting area being adapted to receive said connector of said second handle.

6. The portable router of claim 5, wherein said connector includes a connecting member and a securing member.

7. The portable router of claim 4, wherein said receiving portion is a cavity extending from said outer surface of said base toward said central bore.

8. The portable router of claim 4, wherein said receiving portion is configured as a mortise.

9. The portable router of claim 8, wherein said mortise has a dovetail shape.

10. The portable router of claim 4, wherein said receiving portion has an open end and a closed end.

11. The portable router of claim 6, wherein said connecting member is configured as a tenon.

12. The portable router of claim 6, wherein said connecting member has a first end and a second end.

13. The portable router of claim 12, wherein said base includes a receiving portion having an open end and a closed end, and said receiving portion receives said connecting member such that said first end of said connecting member is immediately adjacent said closed end of said receiving portion.

14. The portable router of claim 12, wherein said base includes a receiving portion having an open end and a closed end, and said receiving portion receives said connecting member such that said second end of said connecting member is substantially coplanar with said open end of said receiving portion.

15. The portable router of claim 6, wherein said second handle further includes a central portion and a graspable portion.

16. The portable router of claim 15, wherein said securing member is a thumb screw.

17. The portable router of claim 16, wherein said thumb screw is threadably engageable with said central portion of said second handle and said securing portion of said base.

18. The portable router of claim 2, wherein said first handle is one of an egg-shaped handle and a D-handle.

19. The portable router of claim 18, wherein said first handle is removably attached to said base in an interchangeable manner.

20. The portable router of claim 18, wherein said first handle is fixedly attached to said base.

21. The portable router of claim 18, wherein said second handle is one of an egg-shaped handle and a D-handle.

22. The portable router of claim 15, wherein said graspable portion of said second handle has a plurality of raised regions and a plurality of recessed regions thereon.

23. The portable router of claim 15, wherein said graspable portion has a first end and a second end, said first end of said graspable portion is connected to said central portion by an upper closure portion, and said second end of said graspable portion is connected to said central portion by a lower closure portion.

24. A method for interchanging a handle on a portable router base comprising:
providing a motor;
connecting said motor to a base in an operative manner;
attaching a first handle to said base;
attaching a second handle to said base in a removable manner.

25. A base for a router comprising:
an upper portion and a lower portion, wherein said upper portion is adapted to receive a motor; and
at least one interchangeable handle removably connected to said lower portion.
